(19) United States
(12) Patent Application Publication
(10) Pub. No.: US 2025/0262548 A1
(43) Pub. Date: Aug. 21, 2025

(54) GAME INFORMATION PROCESSING METHOD AND APPARATUS, COMPUTER DEVICE, AND COMPUTER-READABLE STORAGE MEDIUM

(71) Applicant: Tencent Technology (Shenzhen) Company Limited, Shenzhen (CN)

(72) Inventor: Jieqi Xie, Shenzhen (CN)

(21) Appl. No.: 19/174,313

(22) Filed: Apr. 9, 2025

Related U.S. Application Data
(63) Continuation of application No. PCT/CN2024/073783, filed on Jan. 24, 2024.

(30) Foreign Application Priority Data
Apr. 12, 2023 (CN) 202310405154.8

(51) Int. Cl. A63F 13/795; A63F 13/87

(52) U.S. Cl. CPC A63F 13/795; A63F 13/87

(57) ABSTRACT

A game information processing includes: presenting a state selection interface in response to a trigger operation on a state setting entry displayed on a game application interface, at least one to-be-selected state type being presented on the state selection interface; determining a target state type in response to a state selection operation received through the state selection interface; presenting a state setting interface when it is determined, based on the target state type, a state setting needs to be performed; acquiring state information in response to a state setting operation received through the state setting interface, the state information including at least state content and interaction permission information; and publishing a state based on the state information in response to a setting completion operation received through the state setting interface, and presenting the state information on a player list interface and a personal information presentation interface.

### CROSS REFERENCE TO RELATED APPLICATIONS

This application is a continuation application of PCT Patent Application No. PCT/CN2024/073783, filed on Jan. 24, 2024, which claims priority to Chinese Patent Application No. 202310405154.8, filed on Apr. 12, 2023, each entitled “GAME INFORMATION PROCESSING METHOD AND APPARATUS, COMPUTER DEVICE, COMPUTER-READABLE STORAGE MEDIUM, AND COMPUTER PROGRAM PRODUCT,” and each of which is incorporated herein by reference in its entirety.

### FIELD

The present disclosure relates to information processing technologies, and in particular, to a game information processing method and apparatus, a computer device, a computer-readable storage medium, and a computer program product.

### BACKGROUND

With the development of terminal technology and Internet technology, games have become one of the most popular forms of entertainment. Through appropriate game matches, players can relax and reduce life stress, and some games can even help improve logical thinking. Currently, communication between players is mostly limited to in-game matches, where they can discuss tactics and schedule a team-up. After the game match, the players can only perform instant messaging with an online friend player. Therefore, the interaction method is limited.

### SUMMARY

Embodiments of the present disclosure provide a game information processing method and apparatus, a computer device, a computer-readable storage medium, and a computer program product, to enrich interaction function of a game and enhance a social expression effect of the game.

Solutions in the embodiments of the present disclosure are implemented as follows.

The embodiments of the present disclosure provide a game information processing method, which is applied to a computer device (e.g., a computing device) and includes:
presenting a state selection interface in response to a trigger operation on a state setting entry displayed on a game application interface, at least one to-be-selected state type being presented on the state selection interface;
determining a target state type in response to a state selection operation received through the state selection interface;
presenting a state setting interface corresponding to the target state type when it is determined, based on the target state type, that state setting needs to be performed;
acquiring state information in response to a state setting operation received through the state setting interface, the state information including at least state content and interaction permission information; and
publishing the state information in response to a setting completion operation received through the state setting interface, and presenting the state information on a player list interface and a personal information presentation interface.

The embodiments of the present disclosure provide a game information processing apparatus, which includes:
a first presentation module, configured to present a state selection interface in response to a trigger operation on a state setting entry displayed on a game application interface, at least one to-be-selected state type being presented on the state selection interface;
a first determination module, configured to determine a target state type in response to a state selection operation received through the state selection interface;
a second presentation module, configured to present a state setting interface corresponding to the target state type when it is determined, based on the target state type, that state setting needs to be performed;
a first acquisition module, configured to acquire state information in response to a state setting operation received through the state setting interface, the state information includes at least state content and interaction permission information; and
a state publishing module, configured to publish the state information in response to a setting completion operation received through the state setting interface, and present the state information on a player list interface and a personal information presentation interface.

The embodiments of the present disclosure provide a computer device, which includes:
a memory, configured to store computer-executable instructions; and
a processor, configured to execute the computer-executable instructions stored in the memory to implement the game information processing method provided in the embodiments of the present disclosure.

The embodiments of the present disclosure provide a computer-readable storage medium, which has a computer program or computer-executable instructions stored therein. A processor executes the computer program or the computer-executable instructions to implement the game information processing method provided in the embodiments of the present disclosure.

The embodiments of the present disclosure provide a computer program product, which includes a computer program or computer-executable instructions. A processor executes the computer program or the computer-executable instructions to implement the game information processing method provided in the embodiments of the present disclosure.

The embodiments of the present disclosure have the following beneficial effects:

In the embodiments of the present disclosure, the state setting entry is provided on the game application interface, the state selection interface is presented in response to the trigger operation on the state setting entry, and at least one to-be-selected state type is presented on the state selection interface. Further, the target state type is determined in response to the state selection operation received through the state selection interface. When it is determined, based on the target state type, that state setting needs to be performed, the state setting interface corresponding to the target state type is presented. The state setting operation is received through the state setting interface, and the state information including at least the state content and the interaction permission information is acquired based on the state setting operation. When the setting completion operation is received through the state setting interface, the state information is published and is presented on the player list interface and the personal information presentation interface. In this way, by publishing a state in a game application, a player can inform a friend player in a game of next online time, whereby interaction efficiency in the game is improved, asynchronous team-up scheduling is implemented, and team-up efficiency is improved. Furthermore, a mood state and the like can be published, whereby interaction functions of the game are enriched, and a social expression effect of the game is enhanced. Therefore, user stickiness of the game application can be improved.

### BRIEF DESCRIPTION OF THE DRAWINGS

FIG. 1A is a schematic diagram of an interface of inviting a player from a team-up list for team-up in the related art.

FIG. 1B is a schematic diagram of an interface of scheduling a team-up in a game match in the related art.

FIG. 1C is a schematic diagram of an interface of rejecting a team-up invitation according to the related art.

FIG. 2 is a schematic diagram of a network architecture of a game system according to an embodiment of the present disclosure.

FIG. 3 is a schematic structural diagram of a terminal 400-1 according to an embodiment of the present disclosure.

FIG. 4A is a schematic flowchart of an implementation of a game information processing method according to an embodiment of the present disclosure.

FIG. 4B is a processing flowchart of an implementation of acquiring state information according to an embodiment of the present disclosure.

FIG. 5A is a schematic flowchart of an implementation of performing a comment interaction and scheduling a team-up according to an embodiment of the present disclosure.

FIG. 5B is a schematic flowchart of an implementation of reminding players who schedule a team-up to get online in time for team-up according to an embodiment of the present disclosure.

FIG. 6 is a schematic diagram of an implementation of performing an interaction based on a state published by another player according to an embodiment of the present disclosure.

FIG. 7 is a schematic diagram of a personal state setting entry provided in a team-up list according to an embodiment of the present disclosure.

FIG. 8 is a schematic diagram of an interface of displaying a published state in a team-up list according to an embodiment of the present disclosure.

FIG. 9 is a schematic diagram of a state setting interface according to an embodiment of the present disclosure.

FIG. 10 is a schematic diagram of another interface on which a published state is displayed according to an embodiment of the present disclosure.

FIG. 11 is a schematic diagram of a personal home page interface on which a state is displayed according to an embodiment of the present disclosure.

FIG. 12 is a schematic diagram of a new comment reminder identifier displayed in a comment display area according to an embodiment of the present disclosure.

FIG. 13 is a schematic diagram of a state reply interface according to an embodiment of the present disclosure.

FIG. 14 is a schematic diagram of an interface of outputting a notification message by an instant messaging application according to an embodiment of the present disclosure.

FIG. 15 is a schematic diagram of an interface of outputting a prompt message for reminding parties who schedule a team-up about team-up scheduling according to an embodiment of the present disclosure.

FIG. 16 is a schematic flowchart of an implementation of initiating state setting in a game information processing method according to an embodiment of the present disclosure.

FIG. 17 is a schematic flowchart of an implementation of viewing a state of another player and making a comment for scheduling a team-up according to an embodiment of the present disclosure.

FIG. 18 is a schematic flowchart of an implementation of agreeing on scheduling by an initiator of a state and successfully teaming up according to an embodiment of the present disclosure.

### DESCRIPTION OF EMBODIMENTS

The following describes the present disclosure in further details with reference to the accompanying drawings. The described embodiments are not to be considered as a limitation to the present disclosure. All other embodiments obtained by those of ordinary skill in the art without creative efforts fall within the scope of protection of the present disclosure.

In the following description, the term “some embodiments” describes subsets of all possible embodiments. However, “some embodiments” may be the same subset or different subsets of all the possible embodiments, and can be combined with each other without conflict.

In the following description, the terms “first/second/third” are merely intended to distinguish between similar objects rather than describe specific orders. The terms “first/second/third” may, where permitted, be interchangeable in a particular order or sequence, whereby embodiments of the present disclosure described herein may be performed in an order other than that illustrated or described herein.

In the embodiments of the present disclosure, the term “module” or “unit” refers to a computer program having a predetermined function or a part of a computer program, and works together with other related parts to achieve a predetermined objective, and may be fully or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, meanings of all technical and scientific terms used in this embodiment are the same as those usually understood by those skilled in the art to which the present disclosure belongs. The terms used in the embodiments of the present disclosure are merely intended to describe the embodiments of the present disclosure, but are not intended to limit the present disclosure.

To better understand a game information processing method provided in the embodiments of the present disclosure, an information processing method applied to a team-up for a game in the related art is preferentially described.

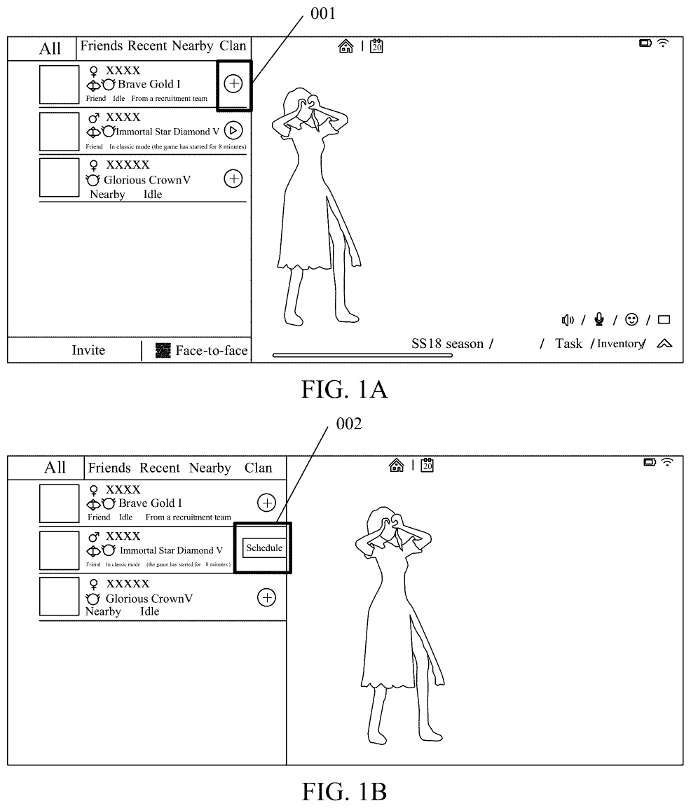

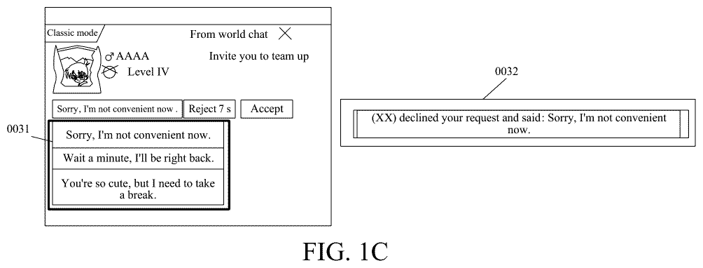

In the related art, when a player is invited for team-up in a game, as shown in FIG. 1A, an online player list may be displayed in a team-up list. An online team-up invitation may be initiated to an invitee by clicking a team-up invitation button 001.

In addition, in a case that both an inviter and an invitee are online, team-up scheduling can be made. When an invited player is in a battle in a game match, an inviting player may click a scheduling button 002 shown in FIG. 1B, to transmit an in-match message to the invited player. The invitee may click a chat box of the game match to accept or reject the scheduling invitation. When the invitee clicks to accept the invitation, after the game match currently played by the invitee is over, if the inviter satisfies a condition, the inviter is automatically added to the invitee's team.

If the invitee receives the team-up invitation and chooses to reject, reply options are available as shown in 0031 in FIG. 1C. A prompt message represented by 0032 in FIG. 1C is presented to the inviting player receiving a rejection message. After receiving the rejection message, the inviting player cannot determine when the invitee will be convenient if the rejection message of “Sorry, I'm not convenient now” is received, or cannot determine how long need to wait if the rejection message of “Wait a minute, I'll be right back” is received. Therefore, a subsequent opportunity to schedule a team-up may be lost. Furthermore, if the invitee is in an offline state, the inviter in the game cannot know when the invitee will get online, and cannot initiate a team-up.

Based on this, according to the game information processing method provided in the embodiments of the present disclosure, to solve a problem that a time for getting online cannot be known in advance and an opportunity of a possible team-up is lost, a method for scheduling a team-up is provided for players, which encourages a player in a team arena game to actively initiate a team-up invitation, whereby other players can have a clear understanding of a game schedule of the player. In this way, a success team-up rate is increased. Furthermore, various states and moods may be set in a game, whereby more functions and a social expression effect of the game can be achieved.

The embodiments of the present disclosure provide a game information processing method and apparatus, a computer device, a computer-readable storage medium, and a computer program product, to solve a problem of a single social communication method in a game and a low success rate of team-up scheduling. The following describes an exemplary application of the computer device (e.g., a computing device) provided in the embodiments of the present disclosure. The device provided in the embodiments of the present disclosure may be implemented as various types of user terminals such as a notebook computer, a tablet computer, a desktop computer, a set-top box, a mobile device (such as a mobile phone, a portable music player, a personal digital assistant, a dedicated message device, or a portable game device), a smartphone, a smart speaker, a smartwatch, a smart television, and an on-board terminal, or may be implemented as a server. Exemplary applications are described below by using examples in which the device is implemented as a terminal.

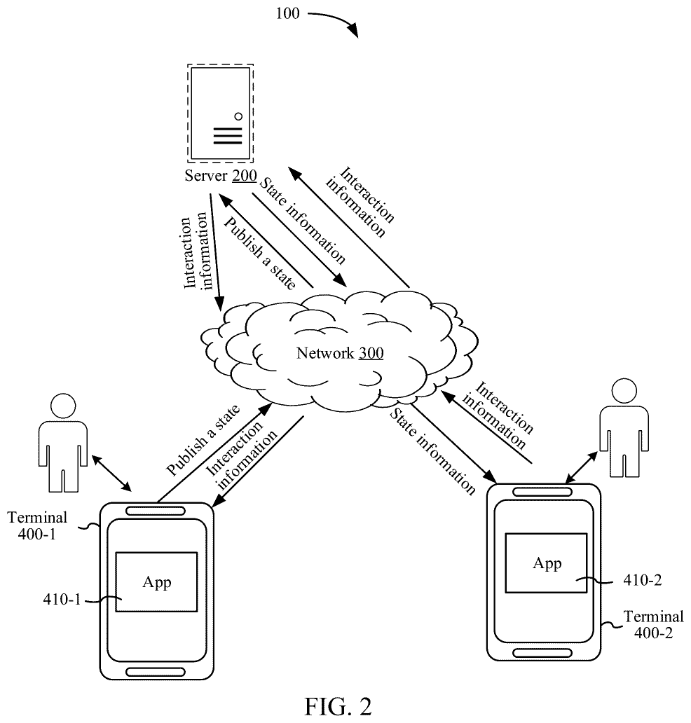

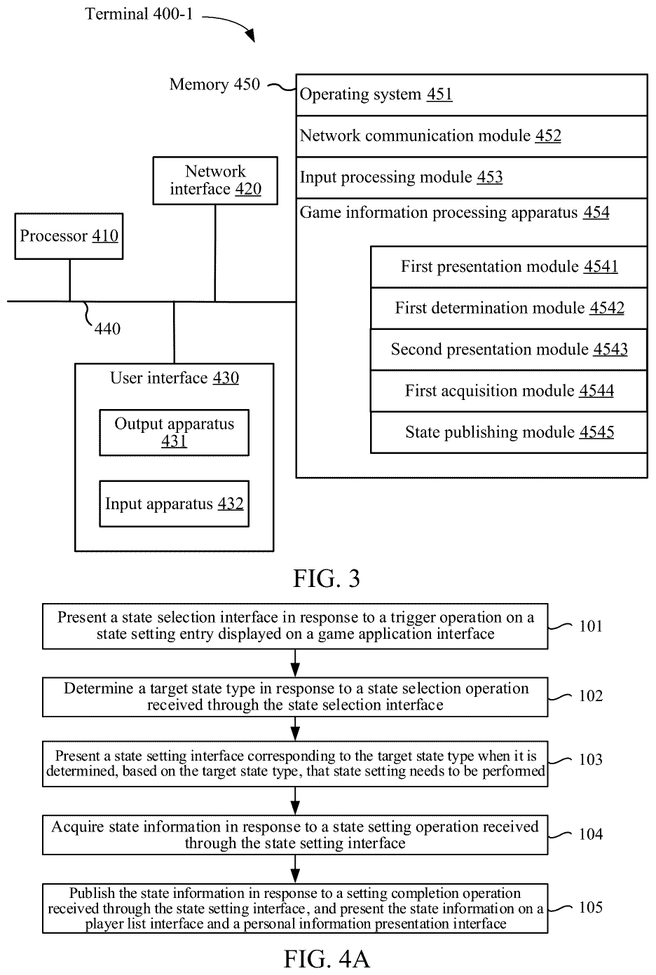

FIG. 2 is a schematic architectural diagram of a game system 100 according to an embodiment of the present disclosure. As shown in FIG. 2, the game system 100 includes a server 200, a network 300, a terminal 400-1, and a terminal 400-2. The terminal 400-1 and the terminal 400-2 are connected to the server 200 over the network 300. The network 300 may be a wide area network, a local area network, or a combination thereof.

As an example, a client 410-1 runs on the terminal 400-1, and a client 410-2 (such as an online game application) runs on the terminal 400-2. The terminal 400-1 and the terminal 400-2 perform game interaction with other users by connecting to a game server (namely, the server 200). In the embodiments of the present disclosure, a state setting entry is provided on a game application interface. The terminal 400-1 presents a state selection interface in response to a trigger operation on the state setting entry, determines a target state type through the state selection interface, presents a state setting interface corresponding to the target state type when determining, based on the target state type, that state setting needs to be performed, and receives a state setting operation through the state setting interface, to acquire state information including at least state content and interaction permission information. When receiving a setting completion operation through the state setting interface, the terminal 400-1 transmits the state information to the server 200, to publish a state, and presents the state information on a player list interface and a personal information presentation interface of the terminal 400-1.

It is assumed that an object identifier of a player corresponding to the terminal 400-1 is included in a player list of the terminal 400-2. After the terminal 400-1 publishes the state, the state published by the player corresponding to the terminal 400-1 may be displayed in the player list of the terminal 400-2. When interaction is permitted for the state, the terminal 400-2 may acquire interaction information corresponding to the state, transmit the interaction information to the terminal 400-1 through the server 200, and output a new interaction reminder message. When the state published by the terminal 400-1 is team-up scheduling and includes time when the player gets online, after logging in to a game and viewing the state published by the terminal 400-1, the terminal 400-2 may perform asynchronous team-up scheduling with the terminal 400-1 by replying to the state information, whereby team-up efficiency is improved. In addition, the terminal 400-1 and the terminal 400-2 can further publish a mood state and the like in the game application, whereby interaction functions of the game are enriched, and a social expression effect of the game is enhanced.

In some embodiments, the server 200 may be an independent physical server, or may be a server cluster or distributed system including a plurality of physical servers, or may be a cloud server providing basic cloud computing services, such as a cloud service, a cloud database, cloud computing, a cloud function, cloud storage, a network service, cloud communication, a middleware service, a domain name service, a security service, a content delivery network (CDN), and a big data and artificial intelligence platform. Each of the terminal 400-1 and the terminal 400-2 may be a smartphone, a tablet computer, a notebook computer, a desktop computer, a smart speaker, a smartwatch, an on-board terminal, or the like, but is not limited thereto. The terminal may be directly or indirectly connected to the server based on a wired or wireless communication protocol. This is not limited in the present disclosure.

FIG. 2 is a schematic structural diagram of a terminal 400-1 according to an embodiment of the present disclosure. The terminal 400-1 shown in FIG. 2 includes: at least one processor 410, a memory 450, at least one network interface 420, and a user interface 430. The components in the terminal 400-1 are coupled through a bus system 440. The bus system 440 is configured to implement communication connection between the components. In addition to a data bus, the bus system 440 further includes a power bus, a control bus, and a state signal bus. For ease of clear description, all types of buses in FIG. 2 are marked as the bus system 440.

The processor 410 may be an integrated circuit chip with a signal processing capability, such as a general-purpose processor, a digital signal processor (DSP), or another programmable logic device (PLD), discrete gate, transistor logic device, or discrete hardware component. The general-purpose processor may be a microprocessor, any conventional processor, or the like.

The user interface 430 includes one or more output apparatuses 431 capable of presenting media content, which includes one or more loudspeakers and/or one or more visual display screens. The user interface 430 further includes one or more input apparatuses 432, which includes user interface members that help user input, such as a keyboard, a mouse, a microphone, a touch display screen, a camera, and other input buttons and controls.

The memory 450 may be removable, non-removable, or a combination thereof. Exemplary hardware devices include a solid-state memory, a hard disk drive, an optical drive, and the like. In an embodiment, the memory 450 includes one or more storage devices that are physically located away from the processor 410.

The memory 450 includes a volatile memory or a non-volatile memory, or may include both a volatile memory and a non-volatile memory. The non-volatile memory may be a read-only memory (ROM), and the volatile memory may be a random-access memory (RAM). The memory 450 described in the embodiments of the present disclosure is intended to include any suitable types of memory.

In some embodiments, the memory 450 can store data to support various operations. Examples of the data include a program, a module, and a data structure, or a subset or a superset thereof, which are exemplarily described below.

An operating system 451 includes system programs for processing various basic system services and performing hardware-related tasks, such as a framework layer, a kernel library layer, and a drive layer, and is configured to implement various basic services and process hardware-based tasks.

A network communication module 452 is configured to access another computer device through one or more (wired or wireless) network interfaces 420. Exemplary network interfaces 420 include: Bluetooth, Wireless Fidelity (Wi-Fi), a universal serial bus (USB), and the like.

An input processing module 453 is configured to detect one or more user inputs or interactions from one of the one or more input apparatuses 432 and translate the detected inputs or interactions.

In some embodiments, the apparatus provided in the embodiments of the present disclosure may be implemented in a software manner. FIG. 2 shows a game information processing apparatus 454 stored in the memory 450. The apparatus may be software in the form of a program and a plug-in, and the like, and includes the following software modules: a first presentation module 4541, a first determination module 4542, a second presentation module 4543, a first acquisition module 4544, a state publishing module 4545. These modules are logical, and may be combined in different manner or further split according to an implemented function. The functions of the modules are described below.

In some other embodiments, the apparatus provided in the embodiments of the present disclosure may be implemented in a hardware manner. As an example, the apparatus provided in the embodiments of the present disclosure may be a processor in the form of a hardware decoding processor. The processor is programmed to perform the game information processing method provided in the embodiments of the present disclosure. For example, the processor in the form of a hardware decoding processor may adopt one or more application-specific integrated circuits (ASICs), DSPs, PLDs, complex PLDs (CPLDs), field-programmable gate arrays (FPGAs), or other electronic elements.

The game information processing method provided in the embodiments of the present disclosure is described with reference to an exemplary application and implementation of the terminal provided in the embodiments of the present disclosure.

The following describes the game information processing method provided in the embodiments of the present disclosure. As stated above, a computer device for implementing the game information processing method according to the embodiments of the present disclosure may be a terminal. Therefore, an execution body of each operation is not repeatedly described below.

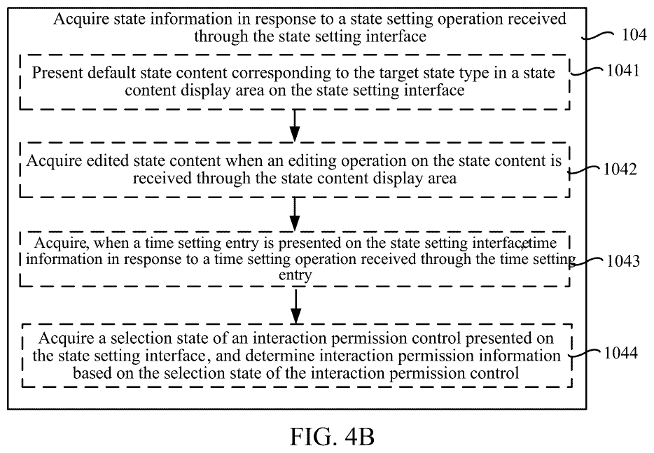

FIG. 4A is a schematic flowchart of a game information processing method according to an embodiment of the present disclosure. The method is described with reference to operations shown in FIG. 4A.

Operation 101: Present a state selection interface in response to a trigger operation on a state setting entry displayed on a game application interface.

In the embodiments of the present disclosure, the state setting entry is added to the game application interface. For example, the state setting entry is presented in a player list display area on the game application interface, or the state setting entry is displayed in a personal information presentation interface (such as a personal home page interface). In this way, state information can be set and published through the state setting entry.

In some embodiments, when the trigger operation on the state setting entry is received, the state selection interface is presented, and at least one to-be-selected state type is presented in the state selection interface. For example, the to-be-selected state type may be a type of team-up invitation, a type of scheduling check-in, a type of publishing a mood, a type of publishing a default state, or the like.

Operation 102: Determine a target state type in response to a state selection operation received through the state selection interface.

In some embodiments, when the state selection operation is received through the state selection interface, the target state type corresponding to the state selection operation is determined based on action point location information of the state selection operation. The target state type is one of the at least one to-be-selected state type.

Operation 103: Present a state setting interface corresponding to the target state type when it is determined, based on the target state type, that state setting needs to be performed.

In some embodiments, different state types have different setting requirements. For example, for a state type of scheduling a team-up, state setting needs to be performed. For example, online time and state content need to be set. For a default state type, state content is fixed by default, whereby state setting does not need to be performed. After the target state type is determined, whether state setting needs to be performed may be determined based on the target state type. For example, whether state configuration needs to be performed is determined by determining whether the target state type is the default state type. If the target state type is the default state type, it is determined that the state setting does not need to be performed. In this case, a prompt interface of confirming publishing of a state is directly presented. When an operation instruction of confirming publishing of a state is received, default state content is published. For example, “CPDD” (Chinese Internet slang, stands for couple dl̅ dl̅,̅ which is configured for searching team members or quick date in video games, and dl̅ dl̅ refers to notification sound) and the like may be published. If the target state type is not the default state type, it is determined that state setting needs to be performed. In this case, the state setting interface corresponding to the target state type is presented. At least a state content editing entry and a selection control of permitting or not permitting interaction are provided on the state setting interface.

Operation 104: Acquire state information in response to a state setting operation received through the state setting interface.

The state information includes at least state content and interaction permission information. Refer to FIG. 4B. In some embodiments, operation 104 is implemented through operation 1041 to operation 1045, which are described below.

Operation 1041: Present default state content corresponding to the target state type in a state content display area on the state setting interface.

In some embodiments, different state types correspond to different default state content. For example, for a type of scheduling a team-up, corresponding default state content is “Please schedule a team-up with me”, or “Schedule a four-person team”. For a type of publishing a mood, corresponding default state content is “Good joy today”.

Operation 1042: Acquire edited state content when an editing operation on the state content is received through the state content display area.

In some embodiments, when a player prefers not to publish the default state content corresponding to the target type, the player triggers the editing operation on the state content through the state content display area, and acquires the edited state content based on the editing operation. The editing operation may be at least one of a deletion operation, a modification operation, and an addition operation on the default state content. For example, the target state type is the type of scheduling a team-up, and the corresponding default state content is “Please schedule a team-up with me”. Edited state content “Start a match this afternoon, please schedule a team-up with me” is obtained through an editing operation on the default state content.

In some embodiments, if no editing operation on the state content is received through the state content display area, the default state content corresponding to the target state type is determined as to-be-published state content.

Operation 1043: Acquire, when a time setting entry is presented on the state setting interface, time information in response to a time setting operation received through the time setting entry.

In some embodiments, when the target state type is a state type for which time needs to be set, for example, the target state type is the type of scheduling a team-up or a type of scheduling check-in, the time setting entry is presented on the state setting interface, and the time setting operation is received through the time setting entry, to acquire the time information. The time information may include year, month, day, hour, and minute. For example, the time information may be Dec. 31, 2022, 20:30.

Operation 1044: Acquire a selection state of an interaction permission control presented on the state setting interface, and determine interaction permission information based on the selection state of the interaction permission control.

The selection state of the interaction permission control may include a selected state and an unselected state. The selection state of the interaction permission control is the selected state by default. When a trigger operation on the interaction permission control is received once, the selection state of the interaction permission control is changed once. For example, a current selection state of the interaction permission control is the selected state, and if the trigger operation on the interaction permission control is received once, the selection state of the interaction permission control is updated to the unselected state.

When the interaction permission control is in the selected state, the interaction permission information indicates that interaction is permitted, and when the interaction permission control is in the unselected state, the interaction permission information indicates that interaction is not permitted. Permission of interaction refers to that another terminal is permitted to reply, give a thumbs-up, or the like to the state information. Non-permission of interaction refers to that another terminal is only permitted to view the state information but is not permitted to reply, give a thumbs-up, or the like to the state information.

Operation 105: Publish the state information in response to a setting completion operation received through the state setting interface, and present the state information on a player list interface and a personal information presentation interface.

In some embodiments, the state information is published in the following manner: a terminal transmits the state information to a server, and the server pushes the state information to another player in the player list. When the state information is presented on the player list interface, a display area of a self-object identifier on the player list interface is determined, and the state information is presented in a preset first state display area in the display area of the self-object identifier. In some embodiments, when the state information is displayed in the first state display area, because a display area of the first state display area is relatively small, only the state content is displayed. When the state information is presented in the personal information presentation interface, the state information is displayed in a preset second state display area in the personal information presentation interface. The state information displayed in the second state display area may include the state content, time information corresponding to a state, and the like.

For example, after a first player publishes a state, if an object identifier of the first player is included in a friend player list of a second player, state information may also be presented in a first state display area in the friend player list of the second player. The first state display area is an area that is configured to display a state in a display area of the object identifier of the first player.

In some embodiments, after publishing the state, the terminal further receives a modification operation on the state information, acquires modified state information in response to the modification operation, publishes the modified state information in response to a publishing operation on the modified state information, and presents the modified state information on the player list interface and the personal information presentation interface.

In some embodiments, after publishing the state, the terminal determines expiration time of the state information, and cancels presentation of the state information on the player list interface and the personal information presentation interface when determining that the expiration time is reached. When the state information does not include the time information, for example, the state information is a mood state published by the player, the expiration time of the state information may be determined based on publishing time of the state information, and may be obtained by adding preset first interval duration to state published time. For example, if the state published time is Mar. 25, 2022, 8:30, and the preset first interval duration is 24 hours, the expiration time of the state information is Mar. 26, 2022, 8:30. When the state information includes the time information, for example, the state information is a state of scheduling a team-up that is published by the player, the time information included in the state information is time for teaming up, or online time of the player, and the expiration time of the state information is obtained by adding preset second interval duration to the time information. For example, if the time information in the state information is Apr. 7, 2023, 22:00, and the second interval duration is 30 minutes, the expiration time of the state information is Apr. 7, 2023, 22:30.

In the embodiments of the present disclosure, the state setting entry is provided on the game application interface, the state selection interface is presented in response to the trigger operation on the state setting entry, and at least one to-be-selected state type is presented on the state selection interface. The target state type is determined in response to the state selection operation received through the state selection interface. The state setting interface corresponding to the target state type is presented when it is determined, based on the target state type, that state setting needs to be performed. The state setting operation is received through the state setting interface, and the state information including at least the state content and the interaction permission information is acquired based on the state setting operation. The state information is published when the setting completion operation is received through the state setting interface, and is presented on the player list interface and the personal information presentation interface. In this way, by publishing a state in a game application, a player can inform a friend player in a game of next online time, whereby interaction efficiency in the game is improved, asynchronous team-up scheduling is implemented, and team-up efficiency is improved. Furthermore, a mood state and the like can be published, whereby interaction functions of the game are enriched, and a social expression effect of the game is enhanced. Therefore, user stickiness of the game application is improved.

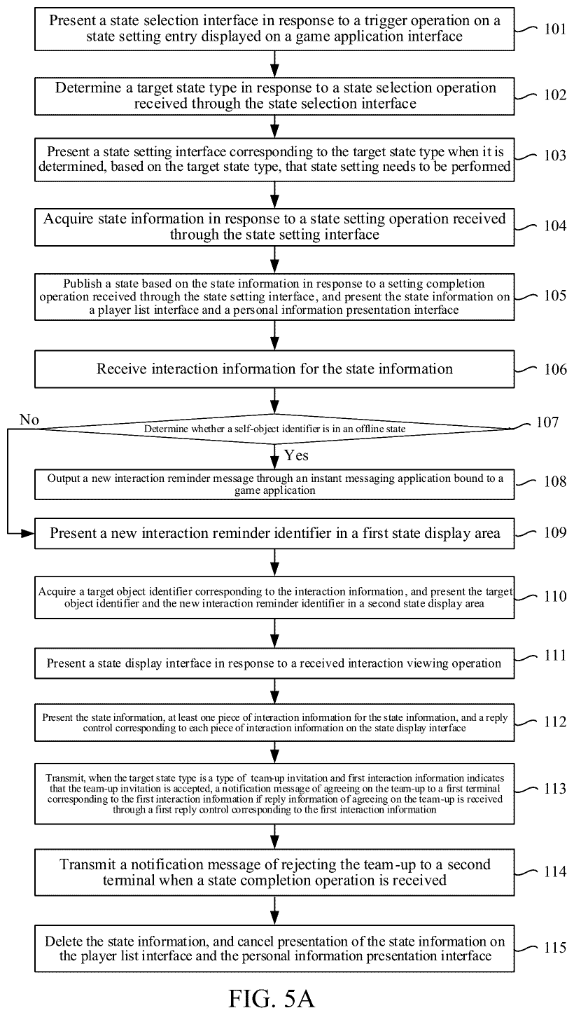

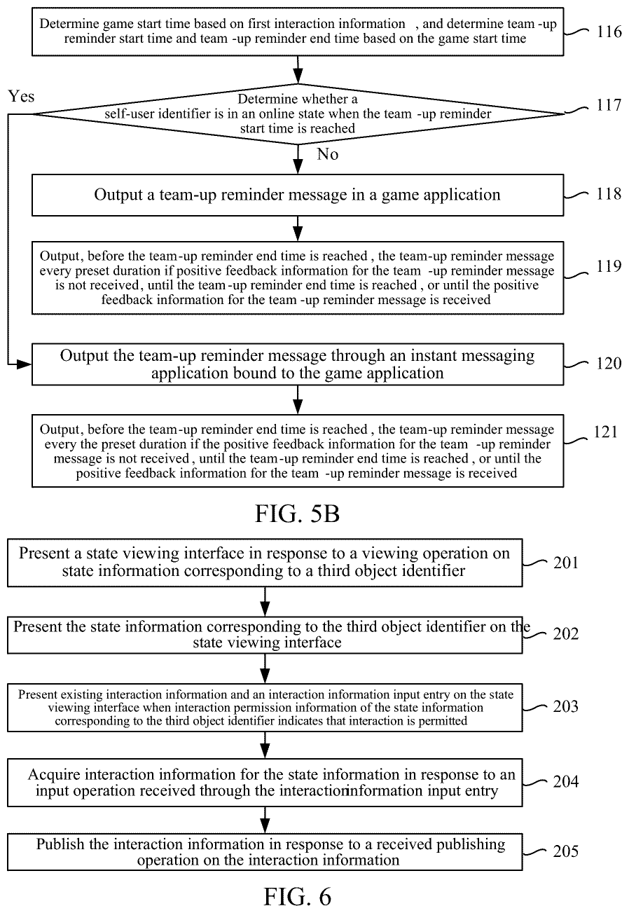

Refer to FIG. 5A. In some embodiments, after the state is published through operation 101 to operation 105, comment interaction and team-up scheduling may be further performed through operation 106 to operation 115, which are described with reference to FIG. 5A.

Operation 106: Receive interaction information for the state information.

In some embodiments, after viewing the state information, another player acquires the interaction information for the state information, and transmits the interaction information to a terminal through a server.

Operation 107: Determine whether a self-object identifier is in an offline state.

If the self-object identifier is in the offline state, it indicates that the player does not log in to a game application and cannot receive a notification message through the game application. In this case, operation 108 is performed. If the self-object identifier is in an online state, it indicates that the player has logged in to the game application and can receive the notification message through the game application. In this case, operation 109 is performed.

Operation 108: Output a new interaction reminder message through an instant messaging application bound to a game application.

In some embodiments, if the self-object identifier is in the offline state, that is, the player is not online, it indicates that the player does not log in to the game application and cannot receive the notification message through the game application. Therefore, to enable the player to receive in time an interaction comment made by another player on a state published by the player, in the embodiments of the present disclosure, the new interaction reminder message is outputted by a third-party instant messaging application bound to the game application.

Operation 109: Present a new interaction reminder identifier in a first state display area.

In some embodiments, the first state display area is a display area in a player list interface. Because a plurality of player identifiers are displayed on the player list interface, and each player identifier occupies a limited display area, only the new interaction reminder identifier is presented in the first state display area. The new interaction reminder identifier may be presented at an upper right corner of the first state display area. The new interaction reminder identifier may be a red dot, or may be a quantity of pieces of unread interaction information. For example, if there are 3 pieces of unread interaction information, the new interaction reminder identifier may be a digit 3.

Operation 110: Acquire a target object identifier corresponding to the interaction information, and present the target object identifier and the new interaction reminder identifier in a second state display area.

In some embodiments, the second state display area is an area that is in a personal information presentation interface and that is configured to display a state. A size of the second state display area is generally greater than a size of the first state display area. Therefore, when the interaction information for the state information is received, the new interaction reminder identifier and the target object identifier corresponding to the interaction information may be displayed in the second state display area. When a plurality of pieces of interaction information are received, the target object identifier displayed in the second state display area may be an object identifier of latest interaction information that is received, or target object identifiers corresponding to the plurality of pieces of interaction information may be displayed in a scrolling manner.

Operation 111: Present a state display interface in response to a received interaction viewing operation.

In some embodiments, the state display interface is presented in the form of a floating window. The state display interface is presented above a game application interface, and an interface size of the state display interface may be less than or equal to an interface size of the game application interface.

Operation 112: Present the state information, at least one piece of interaction information for the state information, and a reply control corresponding to each piece of interaction information on the state display interface.

In some embodiments, the state information is displayed in a first area of the state display interface, and the at least one piece of interaction information for the state information and the reply control corresponding to each piece of interaction information are displayed in a second area of the state display interface.

For example, the first area is an upper half area of the state display interface, and the second area is a lower half area; or the first area is a left half area of the state display interface, and the second area is a right half area.

In some embodiments, the target object identifier corresponding to each piece of interaction information is further displayed in the second area. The target object identifier includes at least a target user name, and may further include a target user avatar.

Operation: Transmit, when the target state type is a type of team-up invitation and first interaction information indicates that the team-up invitation is accepted, a notification message of agreeing on the team-up to a first terminal corresponding to the first interaction information if reply information of agreeing on the team-up is received through a first reply control corresponding to the first interaction information.

When the target state type is the type of team-up invitation, for the state information, the interaction information of accepting the team-up invitation may be received, or another interaction message may be received. For example, the state information is “Team up with me at 10 a.m. today”, for the state information, the received interaction information is an interaction message of accepting the team-up invitation: “I'd like to schedule a team-up with you in a game, see you then!”, or an interaction message of rejecting the team-up invitation: “No time at 10 a.m. today, next time?”, or an interaction message of not determining whether to accept the team-up invitation: “Are you free for a game today, Hahah!”. If the first interaction information is accepting the team-up invitation, and the reply information of agreeing on team up is received through the first reply control corresponding to the first interaction information, it indicates that the player who publishes the state agrees to team up with the player corresponding to the first terminal. In this case, the notification message of agreeing on team-up is transmitted to the first terminal corresponding to the first interaction information.

In some embodiments, when a first object identifier corresponding to the first interaction information is in the online state, it indicates that the first terminal can receive a notification message through the game application. In this case, the notification message of agreeing on team up is transmitted to the first terminal based on the first object identifier and through the game application. When the first object identifier is in the offline state, it indicates that the first terminal cannot receive the notification message through the game application at this moment. In this case, to enable the first terminal to receive the notification message in time, the notification message of agreeing on the team-up may be transmitted to the first terminal through the instant messaging application bound to the game application.

Operation 114: Transmit a notification message of rejecting the team-up to a second terminal when a state completion operation is received.

The second terminal is a terminal other than the first terminal that transmits interaction information of accepting the team-up invitation.

In some embodiments, after determining that team-up scheduling has been completed, the player triggers the state completion operation. When the terminal receives the state completion operation, it indicates that the player no longer needs to team up with another player. In this case, the terminal may transmit the notification message of rejecting the team-up to the second terminal corresponding to another interaction information of accepting the team-up invitation other than the first interaction information, and the second terminal can acquire in time a message indicating that the player who publishes the state has completed the team-up. The notification message of rejecting the team-up may be “I've already teamed up with someone else, let's schedule next time”.

Operation 115: Delete the state information, and cancel presentation of the state information on the player list interface and the personal information presentation interface.

Because the player has already determined a player for team-up by publishing the state, after the state completion operation is received, the state information is deleted, and presentation of the state information on the player list interface and the personal information presentation interface is canceled, to avoid repeated team-up.

According to operation 106 to operation 115, after the player publishes the state, if interaction is permitted for the state, after viewing the state, another player may transmit, based on the state, the interaction information to the terminal that publishes the state for interaction. Furthermore, the new interaction reminder identifier is outputted in the state display area, and a state interaction situation can be known in time. If the published state type is a type of team-up invitation, the terminal that publishes the state may select, after receiving the plurality of interaction messages, a teammate player with whom the terminal intends to team up from the interaction messages of accepting the team-up invitation, and transmit the notification message of agreeing on the team up to the first terminal corresponding to the selected teammate player. In addition, to enable another player who also transmits the interaction information of accepting the team-up invitation to acquire in time the message indicating that the terminal who publishes the state has completed the team-up, after determining that the team-up is completed, the terminal who publishes the state triggers the state completion operation, transmits the notification message of rejecting the team-up to the second terminal corresponding to the other player, deletes the state information, and cancels presentation of the state information on the player list interface and the personal information presentation interface, to avoid receiving again the interaction information of accepting the team-up invitation that is transmitted by the other player.

Refer to FIG. 5B. In some embodiments, after operation 115, two parties who schedule a team-up are reminded to get online in time for team-up before starting a game through operation 116 to operation 121, which are described below with reference to FIG. 5B.

Operation 116: Determine game start time based on first interaction information, and determine team-up reminder start time and team-up reminder end time based on the game start time.

In some embodiments, when a target state type is a type of team-up invitation, and published state information includes online time of a player, after another player views the state information, a replied interaction message of accepting the team-up invitation also carries online time of the other player. The online time of the player who publishes a state may be identical to or different from the online time of the other player who accepts the team-up invitation. When the player who publishes the state receives a plurality of pieces of interaction information of accepting the team-up invitation, and selects another player corresponding to the first interaction information for team-up, it indicates that the player who publishes the state agrees to complete the team-up at online time carried in the first interaction information. Therefore, operation 116 of determining the game start time based on the first interaction information includes: the online time carried in the first interaction information is determined as the game start time.

In some embodiments, if the first interaction information does not carry the online time of the other player, the online time of the player who publishes the state is determined as the game start time.

In some embodiments, the team-up reminder start time is obtained by subtracting preset third interval duration from the game start time, and the team-up reminder end time is obtained by adding the third interval duration to the game start time.

For example, if the game start time is Feb. 5, 2023, 8:45, and the third interval duration is 15 minutes, the preset third interval duration is subtracted from the game start time, that is, Feb. 5, 2023, 8:45 minus 15 minutes, to obtain the team-up reminder start time, namely, Feb. 5, 2023, 8:30, and the third interval duration is added to the game start time, that is, Feb. 5, 2023, 8:45 plus 15 minutes, to obtain the team-up reminder end time, namely, Feb. 5, 2023, 9:00.

Operation 117: Determine whether a self-object identifier is in an online state when the team-up reminder start time is reached.

If the self-object identifier is in the online state, operation 118 is performed. If the self-object identifier is in an offline state, operation 120 is performed.

Operation 118: Output a team-up reminder message in a game application.

In some embodiments, a team-up reminder interface is outputted on a game application interface. The team-up reminder interface may be presented in the form of a floating window. The team-up reminder message is presented on the team-up reminder interface. For example, the team-up reminder message may be “Don't forget your team-up scheduling with A at 8:45 today”.

Operation 119: Output, before the team-up reminder end time is reached, the team-up reminder message every preset duration if positive feedback information for the team-up reminder message is not received, until the team-up reminder end time is reached, or until the positive feedback information for the team-up reminder message is received.

In some embodiments, a “cancel” control and a “team up with him/her” control are further presented on the team reminder interface. When a trigger operation on the “team up with him/her” control is received, it is determined that the positive feedback information for the team-up reminder message is received, and in this case, the team-up reminder message is no longer outputted. If the trigger operation on the “team up with him/her” control is not received, it is determined that the positive feedback information for the team-up reminder message is not received, and the team-up reminder message is outputted every the preset duration, until the team-up reminder end time is reached, or until the positive feedback information for the team-up reminder message is received.

In some embodiments, the preset duration is 5 minutes. That is, the team-up reminder message is outputted every 5 minutes, until the team-up reminder end time is reached, or the positive feedback information for the team-up reminder message is received. In this way, by reminding the player for multiple times, the player is prevented from missing the team-up reminder message, whereby a success team-up rate is increased.

Operation 120: Output the team-up reminder message through an instant messaging application bound to the game application.

In some embodiments, if the self-object identifier is in the offline state, it indicates that the player who publishes the state cannot receive the team-up reminder message through the game application at this moment. To ensure that the team-up reminder message can reach the player who publishes the state in time, the team-up reminder message is outputted through the instant messaging application bound to the game application. For example, the team-up reminder message may be “Don't forget your team-up scheduling with A at 8:45 today, log in to a game and team up quickly”.

Operation 121: Output, before the team-up reminder end time is reached, the team-up reminder message every the preset duration if the positive feedback information for the team-up reminder message is not received, until the team-up reminder end time is reached, or until the positive feedback information for the team-up reminder message is received.

An “ignore” control and a “log in to a game” control may be presented on an interface of outputting the team-up reminder message. When a trigger operation on the “log in to a game” control is received, it is determined that the positive feedback information for the team-up reminder message is received, and in this case, the team-up reminder message is no longer outputted. If the trigger operation on the “log in to the game” control is not received when the team-up reminder end time is reached, it is determined that the positive feedback information for the team-up reminder message is not received, and the team-up reminder message is outputted every the preset duration, until the team-up reminder end time is reached, or until the positive feedback information for the team-up reminder message is received.

In operation 116 to operation 121, after the player completes team-up scheduling, the game start time is determined based on the first interaction information for team-up scheduling, and then the team-up reminder start time and the team-up reminder end time are determined based on the game start time. When the team-up reminder start time is reached, if the self-object identifier is in the online state, the team-up reminder message is outputted in the game application. If the positive feedback information for the team-up reminder information is not received before the team-up reminder end time is reached, the team-up reminder message is outputted every the preset duration, until the team-up reminder end time is reached, or until the positive feedback information for the team-up reminder message is received. In this way, by reminding the player for multiple times, the player is prevented from missing the team-up reminder message, whereby a success team-up rate is increased. In addition, if the self-object identifier is in the offline state, the team-up reminder message is outputted through the instant messaging application bound to the game application. In this way, in case that the player is in the offline state, it can be ensured that the team-up reminder message can reach the player in time, whereby a message interworking rate is increased.

In some embodiments, interaction for a state published by another player is performed through operation 201 to operation 205 shown in FIG. 6, which are described below with reference to FIG. 6.

Operation 201: Present a state viewing interface in response to a viewing operation on state information corresponding to a third object identifier.

The state information corresponding to the third object identifier may be presented in a display area corresponding to the third object identifier in a player list of a current player. When a click operation on the state information corresponding to the third object identifier is received, it is determined that the viewing operation on the state information corresponding to the third object identifier is received. In this case, the state viewing interface is presented.

Operation 202: Present the state information corresponding to the third object identifier on the state viewing interface.

In some embodiments, state content corresponding to the third object identifier and interaction permission information are presented on the state viewing interface. If the state information includes time information, the time information may further be presented on the state viewing interface.

Operation 203: Present existing interaction information and an interaction information input entry on the state viewing interface when interaction permission information of the state information corresponding to the third object identifier indicates that interaction is permitted.

In some embodiments, when the existing interaction information is presented on the state viewing interface, an object identifier corresponding to the existing interaction information is further presented. An input operation on the interaction information may be received through the interaction information input entry.

In some embodiments, when the interaction permission information of the state information corresponding to the third object identifier indicates that interaction is not permitted, the interaction information input entry is not presented on the state viewing interface.

Operation 204: Acquire interaction information for the state information in response to an input operation received through the interaction information input entry.

In some embodiments, the interaction information acquired through the interaction information input entry is text information or an emoticon.

Operation 205: Publish the interaction information in response to a received publishing operation on the interaction information.

In some embodiments, when the interaction permission information of the state information corresponding to the third object identifier indicates that interaction is permitted, a “publish a comment” control is further presented on the state viewing interface. When a trigger operation on the “publish a comment” control is received, it is determined that the publishing operation on the interaction information is received, and the interaction information is published. In some embodiments, the operation of publishing the interaction information includes: the interaction information is transmitted to a server, and the server transmits the published interaction information to a third terminal corresponding to the third object identifier, to output a new interaction reminder identifier on the third terminal.

In operation 201 to operation 205, after the state published by another player in the game application is viewed, interaction between players is implemented by replying to or commenting on the state published by the other player, whereby diversity of interaction functions of a game is improved, and a social expression effect of the game is enhanced.

The following describes exemplary application of the embodiments of the present disclosure in an actual application scenario.

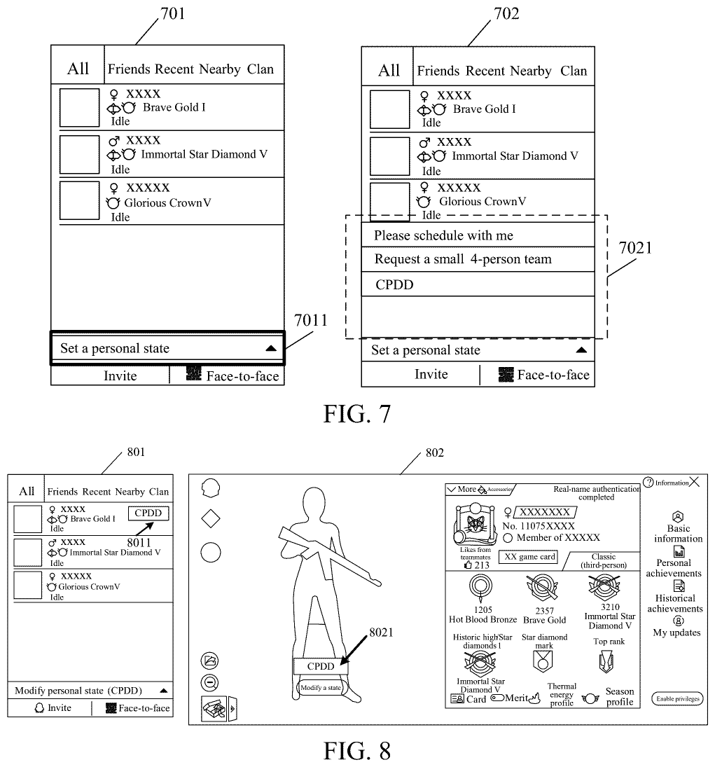

In the embodiment of the present disclosure, a personal state setting function is added to a team-up list display interface in a game application, such as a “set a personal state” control 7011 shown in 701 in FIG. 7. When the “set a personal state” control is clicked or touched, a state type selection interface 7021 shown in 702 in FIG. 7 is presented. Three state types are presented on the state type selection interface 7021: “Please schedule with me”, “Request a small 4-person team”, and “CPDD”.

If “CPDD” is selected, display time of the state does not need to be selected. As shown in 801 in FIG. 8, in a team-up list, the state of “CPDD” is displayed in an upper right corner 8011 of a display area of a player. As shown in 802 in FIG. 8, the state of “CPDD” is displayed in a preset area 8021 in a personal space display interface. If the player does not modify the state, the state is automatically cleared after 24 hours.

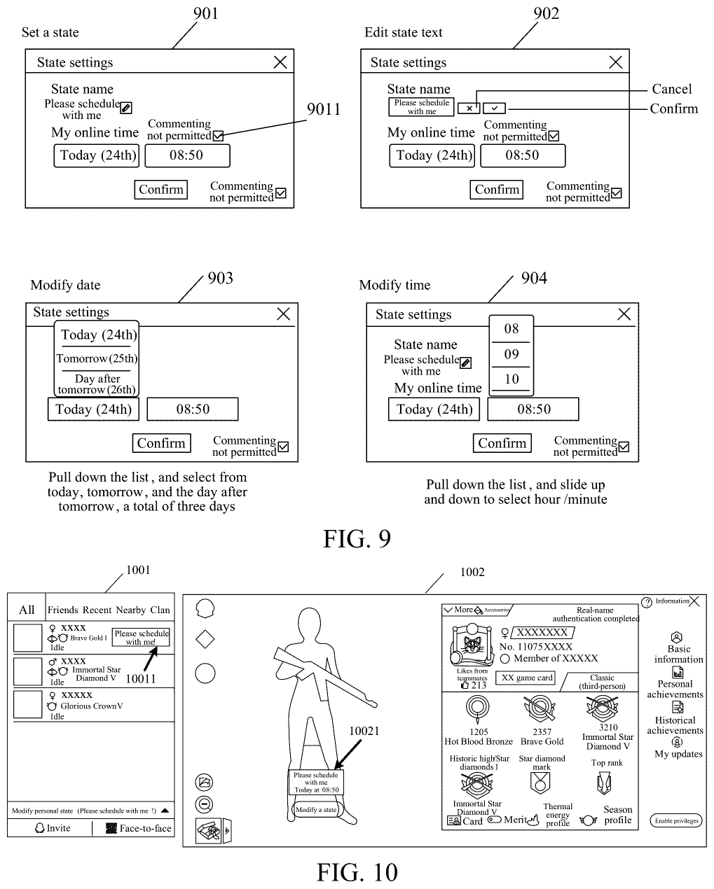

If “Please schedule with me” is selected, a state setting interface 901 shown in FIG. 9 is presented. State text and time may be set through the state setting interface 901. 902 in FIG. 9 is an interface of editing the state text. A state name may be inputted through a state name editing entry, and after editing is completed, a confirmation control is clicked to determine that editing of the state text is completed. 903 in FIG. 9 is an interface of modifying a date, and 904 is an interface of modifying time. The player may select, through interfaces 903 and 904 shown in FIG. 9, time when the player is about to get online.

A selection control 9011 of not permitting commenting is further provided on the state setting interface 901. When the selection control is in a selected state, it indicates that the player selects that commenting is not permitted for the state, and after the state is published, another person cannot reply to the state by making a comment. When the selection control is in an unselected state, it indicates that the player selects that commenting is permitted for the state, and after the state is published, another person can reply to the state by making a comment.

After the player publishes the state, as shown in FIG. 10, the published state is displayed on a player list 1001 and a personal space interface 1002. The published state is displayed in an upper right corner area 10011 of an area that is in the player list 1001 and that is configured to display an identifier of the player, and the published state is displayed in a preset area 10021 of the personal space interface 1002.

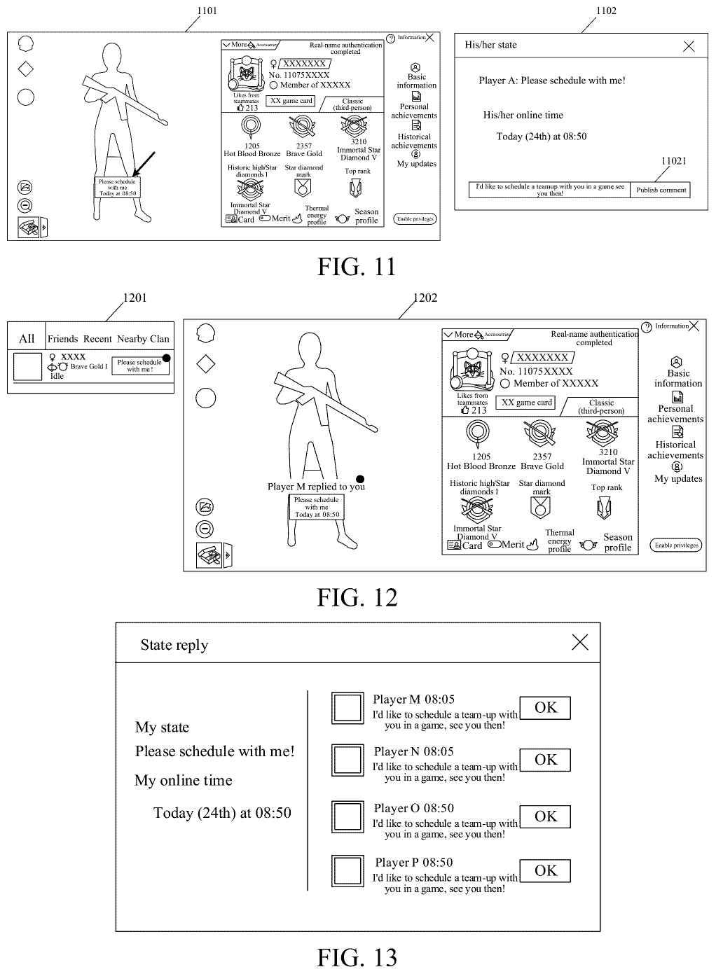

When another player views a personal home page of the player who publishes the state, a personal home page interface shown as 1101 in FIG. 11 is presented. When the other player clicks the state, a state presentation interface shown as 1102 in FIG. 11 is presented, and detailed information about state content and scheduling time may be viewed through the state presentation interface. If commenting is permitted for the state, a comment editing entry is provided on the state presentation interface, a default scheduling comment is displayed on the comment editing entry, and the default scheduling comment may be directly transmitted by clicking a “publish a comment” control 11021. Alternatively, the comment editing entrance may be clicked, comment text is edited, and a comment is published.

When the player who publishes the state receives the comment, a new comment reminder identifier is presented in a comment display area. As shown in FIG. 12, the new comment reminder identifier may be displayed in a state display area of a player list 1201. The new comment reminder identifier may be a red dot. The new comment reminder identifier may also be displayed in a state display area on a personal space interface 1202. Similarly, the new comment reminder identifier may be a red dot. When a touch operation on the state display area is received, a state reply interface shown in FIG. 13 is presented. The state published by the player is presented on the left side of the state reply interface, a reply message of another player is presented on the right side, and a home page of the other player may be viewed by clicking an avatar of the other player. As shown in FIG. 13, the reply message of each player corresponds to one “OK” control. When a touch operation on one “OK” control is received, it is determined that the player corresponding to the “OK” control is selected to complete the scheduling, and at the same time, the scheduling state ends, and the scheduling state of “Please schedule with me” is no longer displayed on the personal home page interface and the team-up list.

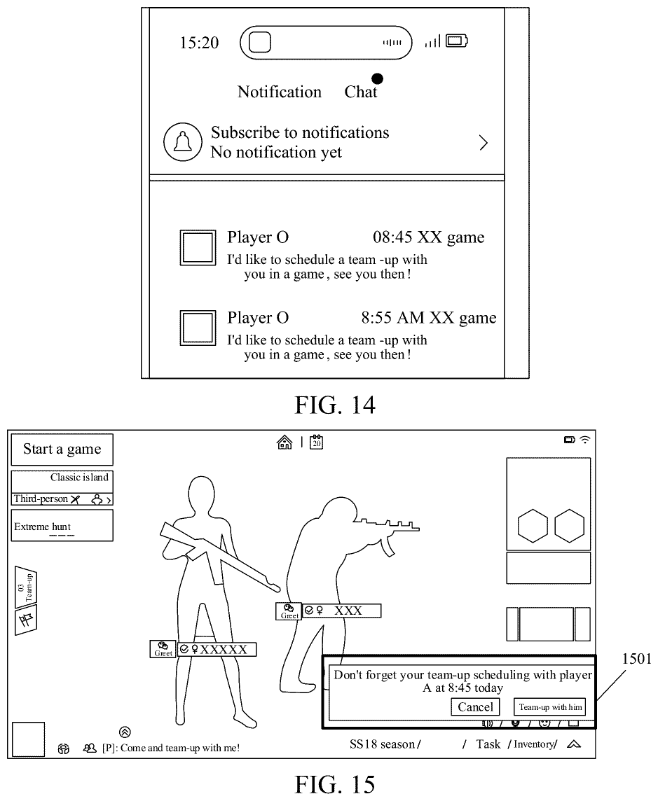

In the embodiments of the present disclosure, when another player makes a comment on the state published by the player, the player may be notified through a game center of a third-party social account bound to a game account. As shown in FIG. 14, when a player O replies a state of “Please schedule with me” published by a player A, a game center of the player A receives a prompt message 1401 shown in FIG. 14. Within a time interval from 15 minutes before scheduled time to 15 minutes after the scheduled time, when both parties who make the schedule log in to a game, a prompt message 1501 shown in FIG. 15 is presented, to remind the both parties of team-up scheduling.

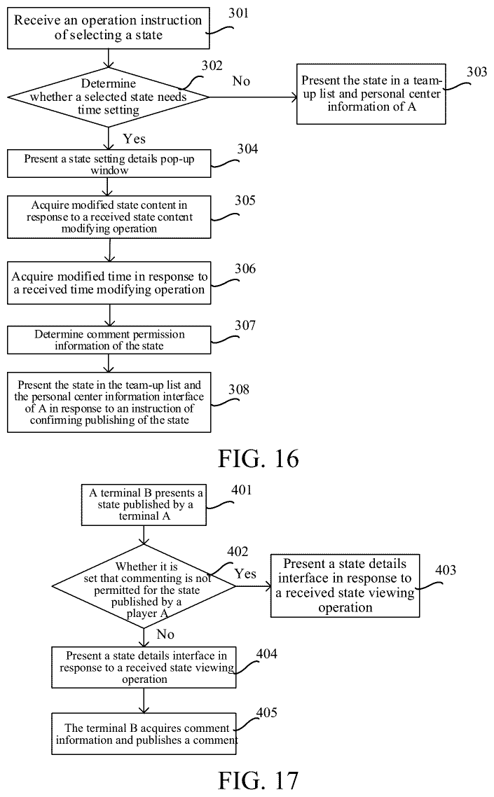

FIG. 16 is a schematic flowchart of an implementation of initiating state setting in a game information processing method according to an embodiment of the present disclosure. An implementation process of initiating state setting is described with reference to FIG. 16.

Operation 301: Receive an operation instruction of selecting a state.

For example, it is assumed that a terminal A is a terminal of a player A, the terminal A receives an operation of the player A on a “set a personal state” control in a team-up list, presents a state selection interface, and presents a plurality of selectable states on the state selection interface. The terminal A receives the operation instruction of selecting a state through the state selection interface, and determines a selected state based on the operation instruction.

Operation 302: Determine whether a selected state needs time setting.

If the state selected by the player A does not need time setting, such as a “CPDD” state, operation 303 is performed. If the state selected by the player A needs time setting, operation 304 is performed.

Operation 303: Present the state in a team-up list and a personal center information interface of a player A.

In some embodiments, when the selected state does not need time setting, after receiving an operation instruction of confirming publishing of the state, the terminal A displays the state in the team-up list and the personal center information interface of A.

Operation 304: Present a state setting details pop-up window.

If the state selected by the player A is a state of scheduling a team-up, such as a state of “Please schedule with me!”, team-up time needs to be set. In this case, the state setting details pop-up window is presented.

Operation 305: Acquire modified state content in response to a received state content modifying operation.

Operation 306: Acquire modified time in response to a received time modifying operation.

Operation 307: Determine comment permission information of the state.

In some embodiments, another player is permitted to comment by default. Alternatively, it may be set, through a comment permission selection control, that the other player is not permitted to comment.

Operation 308: Present the state in the team-up list and the personal center information interface of A in response to an instruction of confirming publishing of the state.

FIG. 17 is a schematic flowchart of an implementation of viewing a state of another person and making a comment on scheduling according to an embodiment of the present disclosure, which is described with reference to FIG. 17.

Operation 401: A terminal B presents a state published by a terminal A.

For example, it is assumed that the terminal B is a terminal of a player B, and a player A is in a team-up list of the player B, when the terminal B presents the team-up list of the player B, a state published by the player A is presented at an upper right corner of a display area of the player A. The terminal B may further present a personal space interface of the player A in response to an operation instruction of viewing the personal space of the player A that is received from the player B. The state published by the player A is also presented in the personal space interface of the player A.

Operation 402: Determine whether it is set that commenting is not permitted for the state published by a player A.

If the player A sets that commenting is not permitted for the state, operation 403 is performed. If the player A does not set that commenting is not permitted for the state, operation 404 is performed.

Operation 403: Present a state details interface in response to a received state viewing operation.

In some embodiments, when receiving an operation of clicking the state, the terminal B determines that the state viewing operation is received. In this case, the state details interface is presented, and state content and time information set by the player A are displayed on the state details interface.

Operation 404: Present the state details interface in response to the received state viewing operation.

In some embodiments, if the player A sets that commenting is permitted for the state, the terminal B presents the state details interface in response to the received state viewing operation.

In addition, the state details interface presented in operation 404 includes not only the state content and the time information set by the player A, but also a comment editing entry. comment.

Operation 405: The terminal B acquires comment information and publishes a

In some embodiments, if the player A sets that commenting is permitted for the state, the comment editing entry is provided on the state details interface, and the terminal B acquires the comment information through the comment editing entry, and publishes the comment on the state when receiving an operation instruction of publishing the comment.

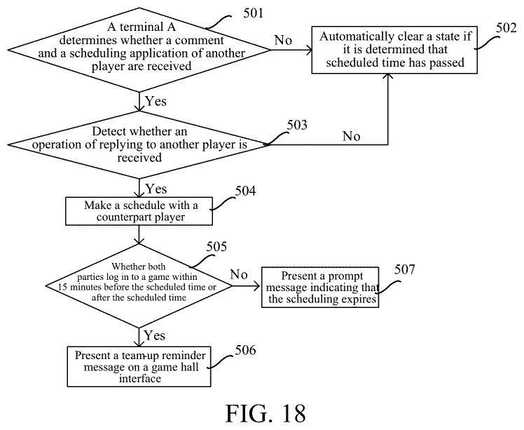

FIG. 18 is a schematic flowchart of an implementation of agreeing on scheduling by an initiator of a state and successfully teaming up according to an embodiment of the present disclosure, which is described below with reference to FIG. 18.

Operation 501: A terminal A determines whether a comment and a scheduling application of another player are received.

When the comment and the scheduling application of the other player are not received, operation 502 is performed. When the comment and the scheduling application of the other player are received, operation 503 is performed.

Operation 502: Automatically clear a state if it is determined that scheduled time has passed.

In some embodiments, when the scheduled time set for the state has passed, the state is automatically cleared, that is, the state is no longer displayed.

Operation 503: Detect whether an operation of replying to another player is received.

If the operation of replying to another player is not received, operation 502 is performed. If the operation of replying to another player is received, operation 504 is performed.

Operation 504: Make a schedule with a counterpart player.

Operation 505: Determine whether both parties log in to a game within 15 minutes before the scheduled time or after the scheduled time.

If both parties who make the schedule log in to the game within 15 minutes before or after the scheduled time, operation 506 is performed. If both parties who make the schedule have not logged in to the game within 15 minutes before and 15 minutes after the scheduled time, operation 507 is performed.

Operation 506: Present a team-up reminder message on a game hall interface.

Operation 507: Present a prompt message indicating that the schedule expires.

In the embodiments of the present disclosure, the player may set a personal state in a game, set a particular event and trigger time, and present the personal event and the trigger time to another player. The other player may perform state interaction with the player, may schedule a team-up, schedule check-in, and the like according to the event and the time set by the player, and transmit a notification to a social account bound to a game account of the player, to ensure that schedule information can reach the player in time. In this way, convenience of game scheduling and a message access probability can be improved, and asynchronous team-up scheduling is implemented, and a success team-up rate is increased. In addition, the game information processing method provided in the embodiments of the present disclosure can be applied to not only team-up scheduling, but also a scheduling service with strict activity time. The player may quickly set activity participation time and a type in a game, and synchronize the activity participation time and the type to a personal central state, and other players can view the information, which ensures that the other players can participate in an activity in time. Meanwhile, the player may set various states and moods of a personal character, which bears more functions and social expression effects.

In the embodiments of the present disclosure, relevant data, such as user information and state information, is involved. When the embodiments of the present disclosure are applied to a specific product or technology, user permission or consent needs to be obtained, and collection, use, and processing of the relevant data need to comply with relevant laws, regulations, and standards of relevant countries and regions.

The following continues to describe an exemplary structure of a game information processing apparatus 454 provided in the embodiments of the present disclosure that is implemented as a software module. In some embodiments, as shown in FIG. 2, software modules in a game processing apparatus 454 stored in a memory 450 include:
a first presentation module 4541, configured to present a state selection interface in response to a trigger operation on a state setting entry displayed on a game application interface, at least one to-be-selected state type being presented on the state selection interface; a first determination module 4542, configured to determine a target state type in response to a state selection operation received through the state selection interface; a second presentation module 4543, configured to present a state setting interface corresponding to the target state type when it is determined, based on the target state type, that state setting needs to be performed; a first acquisition module 4544, configured to acquire state information in response to a state setting operation received through the state setting interface, the state information including at least state content and interaction permission information; and a state publishing module 4545, configured to publish the state information in response to a setting completion operation received through the state setting interface, and present the state information on a player list interface and a personal information presentation interface.

In some embodiments, the first acquisition module 4544 is further configured to: present default state content corresponding to the target state type in a state content display area on the state setting interface; acquire modified state content when a modification operation on the state content is received through the state content display area; acquire, when a time setting entry is presented on the state setting interface, time information in response to a time setting operation received through the time setting entry; and determine, when an interaction permission control is presented on the state setting interface, the interaction permission information based on a selection state of the interaction permission control, the interaction permission information indicating that interaction is permitted when the interaction permission control is in a selected state, and the interaction permission information indicating that interaction is not permitted when the interaction permission control is in an unselected state.

In some embodiments, the state publishing module 4545 is further configured to: determine a display area of a self-object identifier on the player list interface, and present the state information in a preset first state display area in the display area of the self-object identifier; and display the state information in a preset second state display area on the personal information presentation interface.

In some embodiments, the apparatus further includes: a first output module, configured to output, when interaction information for the state information is received, a new interaction reminder message through an instant messaging application bound to a game application if the self-object identifier is in an offline state; a third presentation module, configured to present the new interaction reminder identifier in the first state display area if the self-object identifier is in an online state; and a second acquisition module, configured to acquire a target object identifier corresponding to the interaction information, and present the target object identifier and the new interaction reminder identifier in the second state display area.

In some embodiments, the apparatus further includes: a fourth presentation module, configured to present a state display interface in response to a received interaction viewing operation; a fifth presentation module, configured to present the state information, at least one piece of interaction information for the state information, and a reply control corresponding to each piece of interaction information on the state display interface; and a first transmission module, configured to transmit, when the target state type is a type of team-up invitation and first interaction information indicates that the team-up invitation is accepted, a notification message of agreeing on the team-up to a first terminal corresponding to the first interaction information if reply information of agreeing on the team-up is received through a first reply control corresponding to the first interaction information.

In some embodiments, the apparatus further includes: a second transmission module, configured to transmit a notification message of rejecting the team-up to a second terminal when a state completion operation is received, the second terminal being a terminal other than the first terminal that transmits interaction information of accepting the team-up invitation; and a first deletion module, configured to delete the state information, and cancel presentation of the state information on the player list interface and the personal information presentation interface.

In some embodiments, the first transmission module is further configured to: transmit, when a first object identifier corresponding to the first interaction information is in an online state, the notification message of agreeing on the team-up to the first terminal based on the first object identifier and through the game application; and transmit, when the first object identifier is in an offline state, the notification message of agreeing on the team-up to the first terminal through the instant messaging application bound to the game application.

In some embodiments, the apparatus further includes: a second determination module, configured to determine game start time based on the first interaction information, and determine team-up reminder start time and team-up reminder end time based on the game start time; a second output module, configured to output, when the team-up reminder start time is reached, a team-up reminder message in the game application if the self-object identifier is in the online state; and a third output module, configured to output, before the team-up reminder end time is reached, output the team-up reminder message every the preset duration if positive feedback information for the team-up reminder message is not received, until the team-up reminder end time is reached, or until the positive feedback information for the team-up reminder message is received.

In some embodiments, the apparatus further includes: a fourth output module, configured to output, when the team-up reminder start time is reached, the team-up reminder message through the instant messaging application bound to the game application if the self-object identifier is in the offline state; and a fifth output module, configured to output, before the team-up reminder end time is reached, the team-up reminder message every the preset duration if the positive feedback information for the team-up reminder message is not received, until the team-up reminder end time is reached, or until the positive feedback information for the team-up reminder message is received.

In some embodiments, the apparatus further includes: a sixth presentation module, configured to present a state viewing interface in response to a viewing operation on state information corresponding to a third object identifier; a seventh presentation module, configured to present the state information corresponding to the third object identifier on the state viewing interface; an eighth presentation module, configured to present existing interaction information and an interaction information input entry on the state viewing interface when interaction permission information of the state information corresponding to the third object identifier indicates that interaction is permitted; a third acquisition module, configured to acquire interaction information for the state information in response to an input operation received through the interaction information input entry; and an interaction publishing module, configured to publish the interaction information in response to a received publishing operation on the interaction information.

In some embodiments, the apparatus further includes: a fourth acquisition module, configured to acquire modified state information in response to a modification operation on the state information; and a ninth presentation module, configured to publish the modified state information in response to a publishing operation on the modified state information, and present the modified state information on the player list interface and the personal information presentation interface.

In some embodiments, the apparatus further includes: a fifth acquisition module, configured to determine expiration time of the state information; and a presentation canceling module, configured to cancel presentation of the state information on the player list interface and the personal information presentation interface when it is determined that the expiration time is reached.

In some embodiments, the fifth acquisition module is further configured to: acquire publishing time of the state information and preset first interval duration when the state information does not include the time information; add the first interval duration to the publishing time, to obtain the expiration time of the state information; acquire preset second interval duration when the state information includes the time information, and add the second interval duration to the time information, to obtain the expiration time of the state information.

The embodiments of the present disclosure provide a computer program product, which includes a computer program or computer-executable instructions. The computer program or the computer-executable instructions are stored in a computer-readable storage medium. A processor of a computer device reads the computer-executable instructions from the computer-readable storage medium, and executes the computer-executable instructions, to cause the computer device to perform the foregoing game information processing method according to the embodiments of the present disclosure.

The embodiments of the present disclosure provide a computer-readable storage medium having computer-executable instructions stored therein, which has the computer-executable instructions or a computer program stored therein. A processor executes the computer-executable instructions or the computer program, to cause the processor to perform the foregoing game information processing method according to the embodiments of the present disclosure, such as the game information processing method shown in FIG. 4A.

In some embodiments, the computer-readable storage medium is a memory such as an RAM, an ROM, a flash memory, a magnetic surface memory, an optical disk, or a compact disc ROM (CD-ROM); or is any device including one of or any combination of the foregoing memories.

In some embodiments, the computer-executable instructions are written in the form of a program, software, a software module, a script, or code and according to a programming language (including a compiler or interpreter language or a declarative or procedural language) in any form, and is deployed in any form, including an independent program or a module, a component, a subroutine, or another unit suitable for use in a computing environment.

As an example, the computer-executable instructions may, but not necessarily, correspond to a file in a file system, and may be stored in a part of the file that stores other programs or data, for example, stored in one or more scripts in a Hypertext Markup Language (HTML) document, stored in a single file dedicated to the program under discussion, or stored in a plurality of collaborative files (such as a file that stores one or more modules, subroutines, or code parts).

As an example, the program instructions may be deployed to be executed on a computer device, or deployed to be executed on a plurality of computer devices at the same location, or deployed to be executed on a plurality of computer devices that are distributed in a plurality of locations and interconnected over a communication network.

The foregoing descriptions are merely examples of the present disclosure and are not intended to limit the scope of protection of the present disclosure. Any modification, equivalent replacement, or improvement made within the spirit and scope of the present disclosure fall within the scope of protection of the present disclosure.

What is claimed is:

1. A game information processing method, applied to a computing device and comprising:
presenting, in response to a trigger operation on a state setting entry displayed on a game application interface, a state selection interface, wherein at least one to-be-selected state type is presented on the state selection interface;
determining, in response to a state selection operation received through the state selection interface, a target state type;
presenting, based on the determining, a state setting interface corresponding to the target state type, wherein, based on the target state type, a state setting needs to be performed;
acquiring, in response to a state setting operation received through the state setting interface, state information, wherein the state information comprises at least state content and interaction permission information; and
publishing, in response to a setting completion operation received through the state setting interface, the state information, and presenting the state information on a player list interface and a personal information presentation interface.

2. The method according to claim 1, wherein the acquiring, in response to the state setting operation received through the state setting interface, the state information comprises:
presenting default state content corresponding to the target state type in a state content display area on the state setting interface;
acquiring, based on a modification operation on the state content being received through the state content display area, modified state content;
acquiring, based on a time setting entry being presented on the state setting interface and in response to a time setting operation being received through the time setting entry, time information; and
determining, based on an interaction permission control being presented on the state setting interface and based on a selection state of the interaction permission control, the interaction permission information, wherein the interaction permission information indicates that:
interaction is permitted based on the interaction permission control being in a selected state, and
interaction is not permitted based on the interaction permission control being in an unselected state.

3. The method according to claim 1, wherein the presenting the state information on the player list interface and the personal information presentation interface comprises:
determining a display area of a self-object identifier on the player list interface, and presenting the state information in a preset first state display area in the display area of the self-object identifier; and
presenting the state information in a preset second state display area on the personal information presentation interface.

4. The method according to claim 3, further comprising:
outputting, based on interaction information for the state information being received and based on the self-object identifier being in an offline state, a new interaction reminder message through an instant messaging application bound to a game application;
presenting, based on the self-object identifier being in an online state, a new interaction reminder identifier in the preset first state display area; and
acquiring a target object identifier corresponding to the interaction information, and presenting the target object identifier and the new interaction reminder identifier in the preset second state display area.

5. The method according to claim 4, further comprising:
presenting, in response to a received interaction viewing operation, a state display interface;
presenting the state information, at least one piece of interaction information for the state information, and a reply control corresponding to each piece of interaction information on the state display interface; and
transmitting, based on the target state type being a type of team-up invitation, based on first interaction information indicating that the team-up invitation is accepted, and based on reply information of agreeing on a team-up being received through a first reply control corresponding to the first interaction information, a notification message of agreeing on the team-up to a first terminal corresponding to the first interaction information.

6. The method according to claim 5, further comprising:
transmitting, based on a state completion operation being received, a notification message of rejecting the team-up to a second terminal when, wherein the second terminal is a terminal other than the first terminal that transmits interaction information of accepting the team-up invitation; and
deleting the state information, and canceling the presentation of the state information on the player list interface and the personal information presentation interface.

7. The method according to claim 5, wherein the transmitting the notification message of agreeing on the team-up to the first terminal corresponding to the first interaction information comprises:
transmitting, based on a first object identifier corresponding to the first interaction information is being an online state and based on the first object identifier, the notification message of agreeing on the team-up to the first terminal through the game application; and
transmitting, based on the first object identifier being in an offline state, the notification message of agreeing on the team-up to the first terminal through the instant messaging application bound to the game application.

8. The method according to claim 5, further comprising:
determining, based on the first interaction information, game start time, and determining, based on the game start time, team-up reminder start time and team-up reminder end time;
outputting, based on the team-up reminder start time being reached and based on the self-object identifier being in the online state, a team-up reminder message in the game application; and
outputting, before the team-up reminder end time is reached and based on positive feedback information for the team-up reminder message being not received, the team-up reminder message every a preset duration, until the team-up reminder end time is reached, or until the positive feedback information for the team-up reminder message is received.

9. The method according to claim 8, further comprising:
outputting, based on the team-up reminder start time being reached and based on the self-object identifier being in the offline state, the team-up reminder message through the instant messaging application bound to the game application; and
outputting, before the team-up reminder end time is reached and based on the positive feedback information for the team-up reminder message being not received, the team-up reminder message every the preset duration, until the team-up reminder end time is reached, or until the positive feedback information for the team-up reminder message is received.

10. The method according to claim 1, further comprising:
presenting, in response to a viewing operation on state information corresponding to a third object identifier, a state viewing interface;
presenting the state information corresponding to the third object identifier on the state viewing interface;
presenting, based on interaction permission information of the state information corresponding to the third object identifier indicating that interaction is permitted, existing interaction information and an interaction information input entry on the state viewing interface;
acquiring, in response to an input operation being received through the interaction information input entry, interaction information for the state information; and
publishing, in response to a received publishing operation on the interaction information, the interaction information.

11. The method according to claim 1, further comprising:
acquiring, in response to a modification operation on the state information, modified state information; and
publishing, in response to a publishing operation on the modified state information, the modified state information, and presenting the modified state information on the player list interface and the personal information presentation interface.

12. The method according to claim 1, further comprising:
determining expiration time of the state information; and
canceling, based on the expiration time being reached, the presentation of the state information on the player list interface and the personal information presentation interface.

13. The method according to claim 12, wherein the determining the expiration time of the state information comprises:
acquiring, based on the state information not comprising time information, publishing time of the state information and a preset first interval duration;
adding the preset first interval duration to the publishing time, to obtain the expiration time of the state information;
acquiring, based on the state information comprising the time information, a preset second interval duration; and
adding the preset second interval duration to the time information, to obtain the expiration time of the state information.

14. A computing device, comprising:
one or more processors;
memory storing instructions that, when executed by the one or more processors, cause the electronic device to facilitate:
presenting, in response to a trigger operation on a state setting entry displayed on a game application interface, a state selection interface, wherein at least one to-be-selected state type is presented on the state selection interface;
determining, in response to a state selection operation received through the state selection interface, a target state type;
presenting, based on the determining, a state setting interface corresponding to the target state type, wherein, based on the target state type, a state setting needs to be performed;
acquiring, in response to a state setting operation received through the state setting interface, state information, wherein the state information comprises at least state content and interaction permission information; and
publishing, in response to a setting completion operation received through the state setting interface, the state information, and presenting the state information on a player list interface and a personal information presentation interface.

15. The computing device according to claim 14, wherein the instructions, when executed by the one or more processors, cause the computing device to facilitate:
presenting default state content corresponding to the target state type in a state content display area on the state setting interface;
acquiring, based on a modification operation on the state content being received through the state content display area, modified state content;
acquiring, based on a time setting entry being presented on the state setting interface and in response to a time setting operation being received through the time setting entry, time information; and
determining, based on an interaction permission control being presented on the state setting interface and based on a selection state of the interaction permission control, the interaction permission information, wherein the interaction permission information indicates that:
interaction is permitted based on the interaction permission control being in a selected state, and
interaction is not permitted based on the interaction permission control being in an unselected state.

16. The computing device according to claim 14, wherein the instructions, when executed by the one or more processors, cause the computing device to facilitate:
determining a display area of a self-object identifier on the player list interface, and presenting the state information in a preset first state display area in the display area of the self-object identifier; and
presenting the state information in a preset second state display area on the personal information presentation interface.

17. The computing device according to claim 14, wherein the instructions, when executed by the one or more processors, cause the computing device to facilitate:
presenting, in response to a viewing operation on state information corresponding to a third object identifier, a state viewing interface;
presenting the state information corresponding to the third object identifier on the state viewing interface;
presenting, based on interaction permission information of the state information corresponding to the third object identifier indicating that interaction is permitted, existing interaction information and an interaction information input entry on the state viewing interface;
acquiring, in response to an input operation being received through the interaction information input entry, interaction information for the state information; and
publishing, in response to a received publishing operation on the interaction information, the interaction information.

18. The computing device according to claim 14, wherein the instructions, when executed by the one or more processors, cause the computing device to facilitate:
acquiring, in response to a modification operation on the state information, modified state information; and
publishing, in response to a publishing operation on the modified state information, the modified state information, and presenting the modified state information on the player list interface and the personal information presentation interface.

19. The computing device according to claim 14, wherein the instructions, when executed by the one or more processors, cause the computing device to facilitate:
determining expiration time of the state information; and
canceling, based on the expiration time being reached, the presentation of the state information on the player list interface and the personal information presentation interface.

20. A non-transitory computer-readable storage medium, having computer-executable instructions stored thereon, the computer-executable instructions, when executed by one or more processors of a computing device, cause the computing device to facilitate:
presenting, in response to a trigger operation on a state setting entry displayed on a game application interface, a state selection interface, wherein at least one to-be-selected state type is presented on the state selection interface;
determining, in response to a state selection operation received through the state selection interface, a target state type;
presenting, based on the determining, a state setting interface corresponding to the target state type, wherein, based on the target state type, a state setting needs to be performed;
acquiring, in response to a state setting operation received through the state setting interface, state information, wherein the state information comprises at least state content and interaction permission information; and
publishing, in response to a setting completion operation received through the state setting interface, the state information, and presenting the state information on a player list interface and a personal information presentation interface.
